(19) United States
(12) Patent Application Publication
(10) Pub. No.: US 2013/0166077 A1
(43) Pub. Date: Jun. 27, 2013

(54) APPARATUS AND METHOD OF VIBRATION CONTROL

(71) Applicants: Stephen John Elliott, Hampshire (GB); Michele Zilletti, Hampshire (GB); Paolo Gardonio, Portogruaro (IT)

(72) Inventors: Stephen John Elliott, Hampshire (GB); Michele Zilletti, Hampshire (GB); Paolo Gardonio, Portogruaro (IT)

(73) Assignee: UNIVERSITY OF SOUTHAMPTON, Southampton, Hampshire (GB)

(21) Appl. No.: 13/635,857

(22) PCT Filed: Mar. 18, 2011
(86) PCT No.: PCT/GB2011/050538

§ 371 Date: Mar. 7, 2013

(30) Foreign Application Priority Data
Mar. 19, 2010 (GB) 1004630.8

(51) Int. Cl. G05B 6/02

(52) U.S. Cl. CPC G05B 6/02
USPC 700/280

(57) ABSTRACT

Vibration control apparatus for controlling vibration of a structure (6), the apparatus having an inertial actuator (1), a velocity sensor (4) to measure the velocity of vibration of the structure, and a controller (2) to provide a gain control signal to the actuator. The controller is arranged to determine the gain control signal using at least a measure of velocity from the velocity sensor and a measure of force applied by the actuator to the structure. The controller is further arranged to use the measure of velocity and the measure of force applied to determine a measure of power absorbed by the actuator, and to use the measure of power to determine the gain control signal.

### CROSS-REFERENCE TO RELATED APPLICATIONS

This application claims priority from British Patent Application GB 1004630.8, filed Mar. 19, 2010, and corresponding International Patent Cooperation Treaty Application No. PCT/GB2011/050538, filed Mar. 18, 2011, each fully incorporated herein in their entirety.

### TECHNICAL FIELD

The present invention relates generally to an apparatus and a method of vibration control

### BACKGROUND OF THE INVENTION

The active control of vibration on large structures requires multiple actuators and sensors. The complexity of such a control system scales linearly with the number of actuators and sensors if these are arranged in collocated pairs and controlled using only local, decentralised, feedback. Although the use of such a modular approach to active control has several attractions, to provide good performance they must be able to self-tune their feedback gain to adapt to the environment they find themselves in.

There are a number of advantages to using multiple local feedback loops to control the vibration in structures. These include a complexity that only rises with the number of actuators, a robustness to failure of individual loops and the possibility of mass producing modular systems, including the actuator, sensor and feedback loop.

One important issue with such an arrangement, however, is how the feedback gains are set in the individual loops. The optimum feedback gain is generally a compromise between performance and stability, and its value changes for each loop on a particular structure depending on its position on the structure, the type of vibration and the state of all the other feedback loops. We have realized that the feedback gain of each controller could be adjusted, using only local parameters, to minimize the global vibration of the structure, and this self-tuning would continue in case there were any change in the conditions with time.

We seek to provide an improved apparatus and method of vibration control.

### SUMMARY OF THE INVENTION

According to a first aspect of the invention there is provided a vibration control apparatus for controlling vibration of a structure, the apparatus comprising, an inertial actuator, a velocity sensor to measure the velocity of vibration of the structure, and a controller to provide a gain control signal to the actuator, wherein, the controller arranged to determine the gain control signal using at least a measure of velocity from the velocity sensor and a measure of force applied by the actuator to the structure.

The controller may be arranged to use the measure of velocity and the measure of force applied to determine a measure of power absorbed by the actuator, and the controller further arranged to use the measure of power to determine the gain control signal.

The controller may be arranged to calculate the measure of power absorbed by determining the product of the measure of velocity and the measure of force applied.

The controller is preferably arranged to determine the measure of force applied using the gain control signal sent to the actuator.

The apparatus may comprise a force sensor to measure the force applied by the actuator to provide to the controller a measure of the force applied.

The velocity sensor may comprise an accelerometer.

The velocity sensor may be arranged to be attached to the structure and local to the inertial actuator.

The apparatus may comprise a compensator to reduce the apparent natural frequency of the actuator.

The compensator preferably comprises a null to compensate for the natural frequency of the actuator and a resonance of a frequency lower than the apparent natural frequency.

The controller is preferably such that it has been configured during an initial set-up procedure during which a measured on-line response of the velocity sensor to the control signal is used to suitably configure the controller.

Preferably, the controller has been configured during the initial set-up procedure using an actuator response and the response is deduced from the measured on-line response of the velocity sensor.

Preferably, the compensator has been configured during an initial set-up procedure using an actuator response deduced from on-line measurements of the response of the velocity sensor.

According to a second aspect of the invention there is provided a controller for a vibration control apparatus, the controller comprising a processor, the processor arranged to receive an input indicative of a measure of velocity of vibration of a structure and an input indicative of a measure of force applied to the structure by an inertial actuator, and the processor arranged to provide a gain control signal for the inertial actuator using at least the measure of velocity and the measure of force applied.

The controller preferably includes machine-readable instructions to be executed by the processor.

According to a third aspect of the invention there is provided a method of controlling vibration in a structure using an inertial actuator, the method comprising, determining a measure of velocity of vibration of the structure, determining a measure of force applied by the actuator, using at least the measure of velocity and the measure of force to determine a gain control signal to the actuator.

In a preferred embodiment of the invention self-tuning of local velocity feedback controllers is effected based on the maximisation of their absorbed power, as estimated from the measured velocity signal. For broadband excitations, maximisation of the power absorbed, which requires only local measurements, provides a good approximation to the minimisation of the overall kinetic energy in a structure, corresponding to its global response.

### BRIEF DESCRIPTION OF THE DRAWINGS

Various embodiments of the invention will now be described, by way of example only, with reference to the following drawings in which:

FIG. 1 shows a power spectral density,

FIG. 2 shows a table,

FIGS. 3(a) and 3(b) show the frequency-averaged kinetic energy distributions for different conditions,

FIG. 4 shows a self-tuning arrangement for direct velocity feedback control with an ideal force actuator,

FIG. 5 shows the blocked frequency response of a single degree of freedom model,

FIG. 6 shows the kinetic energy on a panel,

FIGS. 7(a) and 7(b) are plots of the frequency-averaged kinetic energy of a panel and local absorbed power is plotted as a function of feedback gain,

FIG. 8 shows an active vibration control apparatus with an inertial actuator, and

FIG. 9 show plots of frequency averaged kinetic energy and power absorbed by the controller.

### DETAILED DESCRIPTION OF THE PREFERRED EMBODIMENTS

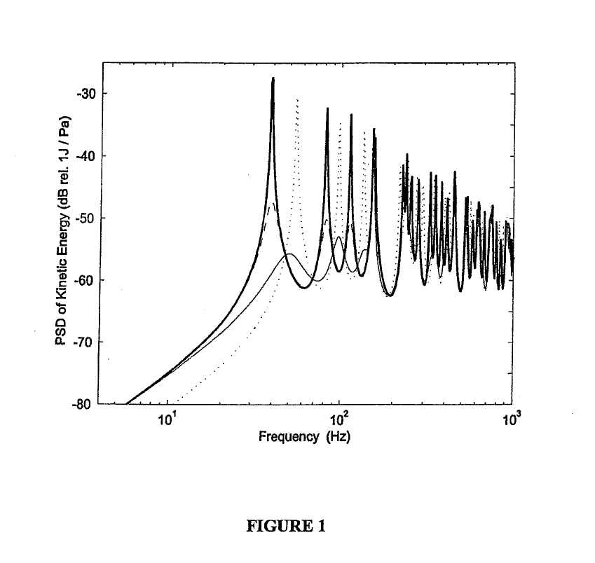

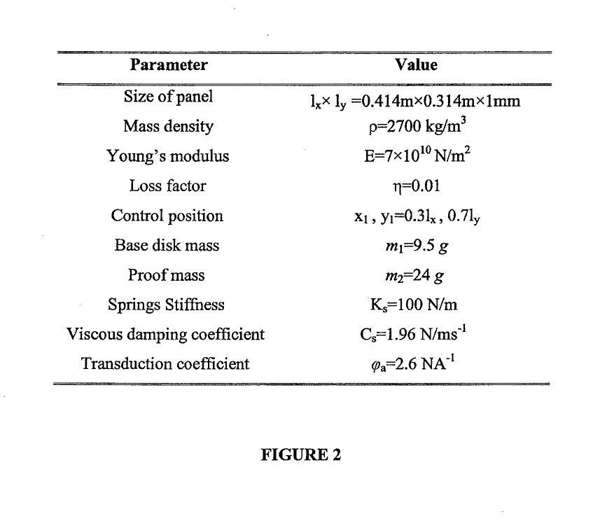

FIG. 1 shows the power spectral density (PSD) of the kinetic energy on a panel of a structure, having the parameters listed in the table shown in FIG. 2, for various values of the feedback gain, γ, of a single feedback loop on the panel, in which the measured velocity is fed back to a collocated force actuator. In FIG. 1, the PSD of the panel's kinetic energy is shown with a local velocity feedback loop driving an ideal force actuator with feedback gains of γ=0 (solid line), γ=7 (dashed line), γ=25 (faint line) and γ=10³ (dotted line). A modal model of the panel is used, which is assumed to be excited by a spatially random white noise signal with a bandwidth from 1 Hz to 1 kHz. When the feedback gain is zero, the original modes of the panel can clearly be seen, and the low order modes are progressively damped as the feedback gain is increased. Beyond a certain gain, however, the feedback loop begins to pin the structure instead of damping it, and a new set of relatively undamped resonances begin to emerge. The local feedback loop with this idealised actuator is acting as a skyhook damper with a damping value determined by the feedback gain. The negative feedback loop can thus only ever absorb mechanical power from the structure, and so the feedback controller is unconditionally stable.

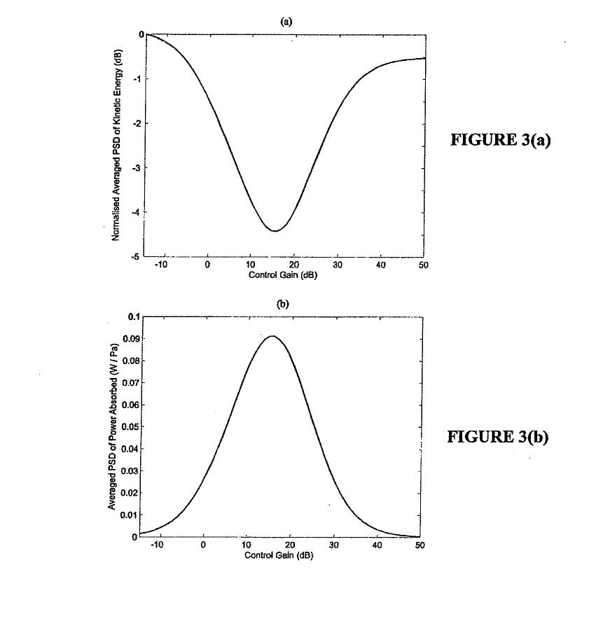

If the frequency-averaged kinetic energy of the panel is calculated for each condition, its variation with feedback gain, normalised by the condition with no control, is shown in FIG. 3(a). It initially decreases as the feedback gain is increased, before increasing again as the controller begins to pin the panel. The optimum feedback gain is approximately equal to the reciprocal of the infinite panel's input mobility. FIG. 3(b) shows the frequency averaged power absorbed by the feedback loop, as a function of the feedback gain. This has a peak at almost the same value of feedback gain as the kinetic energy has a minimum, as one would intuitively expect for broadband excitation since the mechanism of vibration control here is local damping.

The variation of absorbed power with gain suggests that this may be a convenient way to self-tune the feedback gain, using only local parameters to the controller, to achieve a minimum in the kinetic energy, which is a global measure of performance. What is more, the force applied by the controller in this case is, by definition, equal to γv, where γ is the feedback gain, with units of Nsm⁻¹ and v is the local upwards velocity so that the averaged power absorbed, W, is equal to

W= f̅v̅=γ v̅²̅,

where the overbar denotes time averaging. The measured velocity is deliberately defined to be in the opposite direction to the applied force so that γ is a positive quantity for negative feedback. The power absorbed can thus be estimated directly from the mean square value of the measured velocity and the known feedback gain.

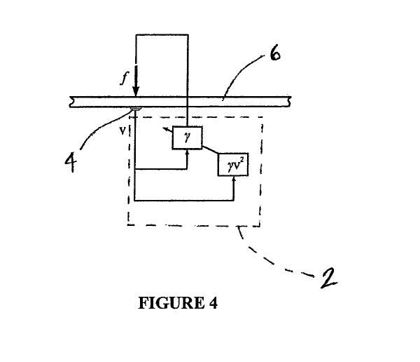

FIG. 4 shows a block diagram of such a self-tuning vibration controller apparatus comprising a controller 2 an actuator 1, and a velocity sensor 4. The actuator 1 is attached to a panel 6. In the illustrated arrangement, the instantaneous value of the measured velocity is directly fed back to the ideal force actuator via the gain γ, whose value is adjusted by an algorithm that maximises the power absorbed, as estimated by γ times the mean square value of the measured velocity. For broadband excitation, the power absorption curve in FIG. 3(b) has a unique global maximum and so a number of algorithms could be used to adjust γ to maximise γ v̅²̅.

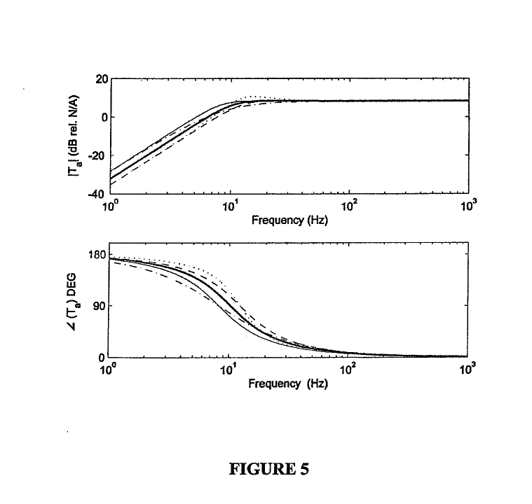

Although the principle of self-tuning to maximise power absorption can be readily demonstrated using idealised force actuators, it is often not possible to use these in practice, since there may be no solid structure to react the force against. Inertial actuators react to the generated force off a proof mass and have been widely used for active vibration control. Above their natural frequency they can behave very much like ideal force actuators over a frequency band of several decades, before higher order resonances interfere with their dynamics. FIG. 5 shows the blocked frequency response of a single degree of freedom model of such a current-driven inertial actuator, with the parameters listed in the table of FIG. 4, which has a natural frequency of about 10 Hz and a damping ratio of about 0.7. The response of the actuator with ±20% variations in both its stiffness and damping are also shown, for later use.

There are a number of additional problems encountered when designing a self-tuning method for a velocity feedback loop with an inertial actuator, compared with that using an ideal force actuator. First, the feedback control loop is no longer unconditionally stable, even under ideal conditions, since the 180° phase shift in the response of the actuator below its natural frequency will give rise to low frequency instabilities if the feedback gain is too high, although an improvement in the maximum gain can be achieved if a compensator is used. It is thus important to adjust the feedback gain much more carefully than in the case of an ideal force actuator, to avoid the system becoming unstable, and so avoid the possibility of damage and enhancement of vibration.

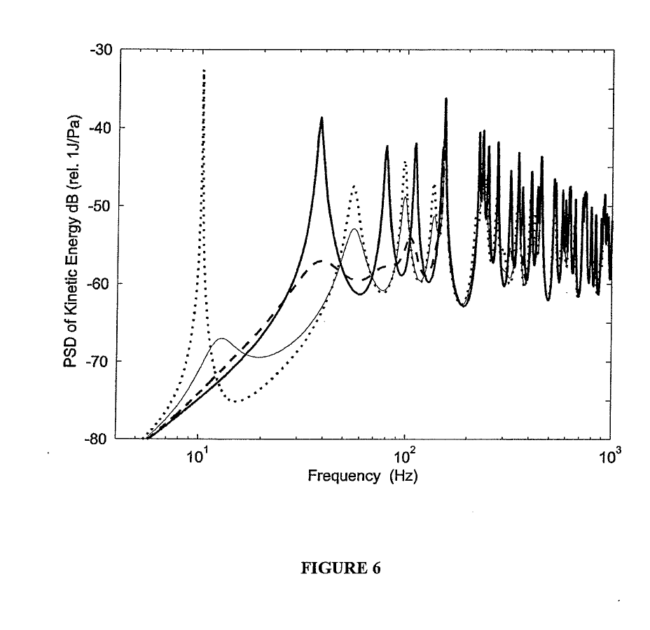

FIG. 6 shows the kinetic energy on the panel referred to above when a direct velocity feedback loop with gain γ is implemented using an inertial actuator modelled as a single degree of freedom system with the characteristics listed in table of FIG. 2. FIG. 6 illustrates feedback gains of γ=0 (solid-line), γ=7 (dashed line), γ=25 (faint line) and γ=51.4 (dashed line). The response of the panel is now more damped, even when the feedback gain is zero, due to the passive loading of the actuator, which acts primarily as a passive damper above its natural frequency. As the feedback gain is increased, significant attenuation is initially obtained at the first few panel resonances, as in FIG. 1 above. At higher gains, however, as well as the additional resonances due to pinning starting to appear, there is also now significant enhancement of the vibration at the natural frequency of the actuator, due to the positive feedback in this frequency region caused by the phase response of the actuator. The feedback gain in this case, in which the actuator is driven by a current, has units of Asm⁻¹, but since the assumed transduction coefficient, φₐ, is 2.6 NA⁻¹, it has a similar numerical value to that used above.

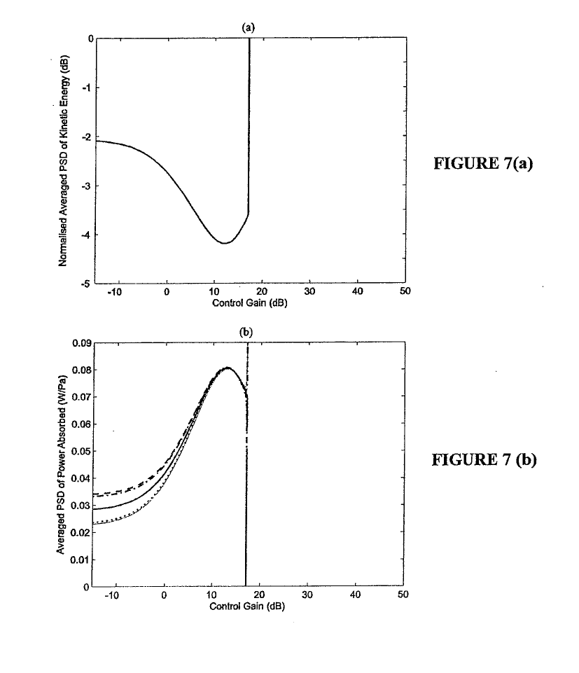

The frequency-averaged kinetic energy of the plate and local absorbed power is plotted as a function of feedback gain in FIGS. 7(a) and 7(b) for this case. In FIGS. 7(a) and 7(b), frequency averaged kinetic energy of the panel (a) and power absorbed by the controller (b) as function of feedback gain for a local velocity feedback controller are shown driving an inertial actuator with a natural frequency of 10 Hz (solid line). Also plotted is the estimated power absorbed when the actuator model is incorrectly identified; +20% ω₀+20% ζ (dashed line), +20% ω₀−20% ζ (dotted line), −20% ω₀₊20% ζ (dash-dotted line), −20% ω₀₋20% ζ (faint line). These graphs are similar to those in FIG. 1 until the critical gain is approached for which the system becomes unstable. An exception at low control gains is that the kinetic energy, normalised by that before the actuator is attached is reduced and the power absorbed by the controller no longer tends to zero. This is because the passive response of the inertial actuator still dissipates power even when the actuator is undriven. As the feedback gain is increased towards the value for which the system becomes unstable, however, the kinetic energy becomes very large and the power absorbed becomes negative. For the arrangement assumed here, the system is only stable for feedback gains below about 52.

The frequency domain results are not valid for higher feedback gains. It is striking how quickly these curves deviate from those using an ideal force actuator as the instability is approached, and it is as if the power absorbed falls off a cliff.

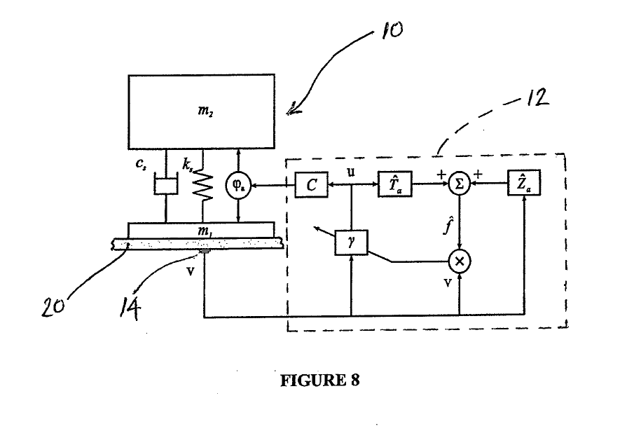

Reference is now made to FIG. 8 which shows a vibration control apparatus comprising an inertial actuator 10, a controller 12, and a velocity sensor 14. The actuator is attached to a panel 20. The controller 12 comprises a processor and an associated memory to store machine readable instructions to be executed by the processor.

The force supplied by the actuator 10 is also no longer directly proportional to the input signal, since the actuator has its own dynamics. These exhibit themselves in two ways, that can be made clear using a superposition approach, assuming only that the actuator is linear, so that the force supplied by the internal actuator 10 to the structure 20 can be written as

f=Tₐu+Zₐv

where we define

$${T}_{a} = \frac{f}{u} {\vert}_{v = 0} and {Z}_{a} = \frac{f}{v} {\vert}_{u = 0} ,$$

so that Tₐ is the blocked frequency response of the actuator, u is the input signal, which may be either voltage or current, Zₐ is the undriven mechanical impedance of the actuator and v is the local upward velocity.

In order to calculate the local power absorbed by the actuator 10, as the product of the force it produces multiplied by the local velocity, it is thus necessary to calculate an estimate of the force, \hat{f}, using estimates of the blocked response and undriven impedance \hat{T}ₐ and \hat{Z}ₐ, so that

\hat{f}=\hat{T}ₐu+\hat{Z}ₐv

as illustrated in FIG. 8. FIG. 8 also shows how this estimate of the absorbed power, {circumflex over ( f̅v̅, is used to tune the feedback gain γ. A compensator, C, is also included before the actuator 10, which is assumed to be unity here, but in general could be used to lower the apparent natural frequency of the actuator, in which case Tₐ and Zₐ would need to be estimated with this compensator in place. It will be evident from the above that the estimate of force, f is derived from gain control signal, u and the measured velocity. It will be appreciated that Tₐ and Zₐ could be obtained for a generic type of actuator, rather than from measurements on a specific case.

One of the potential dangers in this approach is that the actuator dynamics are never known perfectly, and may change with time or operating temperature. A series of further simulations have thus been conducted with ±20% deviations in either the modelled natural frequency or modelled damping ratio of the actuator, which give rise to the modified actuator responses shown in FIG. 5. The effect of these deviations in the modelled response on the estimated power are also plotted in FIG. 7(b), which shows that although the estimated power is somewhat in error for low feedback gains, it retains the same shape as that with an accurate estimate of applied force near its peak and can thus still be reliably used to tune the feedback gain. When the feedback gain is very close to instability, however, and the estimated natural frequency of the actuator is below the true value, there is a sharp spike in the estimated absorbed power. The true force is then very close to being out of phase with the input signal, u, but the estimated force will have less phase shift, since the phase of estimated actuator response is lower than the true value, as can be seen in FIG. 5. In FIG. 5, the blocked frequency response of an inertial actuator, modelled as a single degree of freedom system with the parameters shown in the table of FIG. 2 (solid line) and with ±20% variations in its natural frequency and damping. +20% ω₀+20% ζ (dashed line), +20% ω₀−20% ζ (dotted line), −20% ω₀+20% ζ (dash-dotted line), −20% ω₀−20% ζ (faint line). The estimated absorbed power thus becomes greater than the true power, since the large force and input signal appear to be closer to being in phase. This effect should not prevent the convergence of a practical controller, however, since it occurs so close to the point of instability, which the controller must in any case steer clear of at all cost.

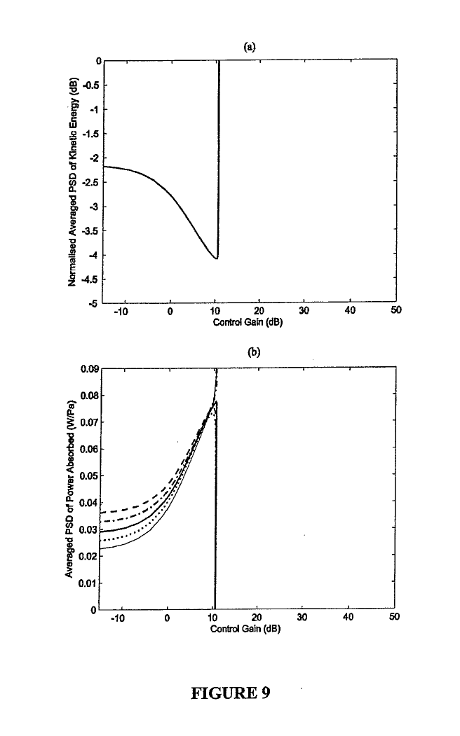

The adaptation algorithm used to adjust the feedback gain based on the estimated power absorbed would thus have to be carefully designed not to stray too close to the unstable region. This is particularly important if the inertial actuator did not have such a low natural frequency, compared with the first structural resonance, as that assumed above. In that case, the maximum in the power absorption curve with an ideal force actuator could occur at a significantly higher feedback gain than the stability limit, so that the optimal feedback gain with the inertial actuator is very close to the limit of stability. This is illustrated in FIG. 9, in which the actuator stiffness is increased so that its natural frequency is changed from 10 Hz to 20 Hz and its damping ratio from 0.7 to 0.35. In FIG. 9, frequency averaged kinetic energy of the panel (a), and power absorbed by the controller (b) as a function of feedback gain for a local velocity feedback controller driving an inertial actuator with a natural frequency of 20 Hz. Also plotted is the estimated power absorbed when the actuator model is incorrectly identified; +20% ω₀+20% ω (dashed line), +20% ω₀−20% ζ (dotted line), −20% ω₀+20% ζ (dash-dotted line), −20% ω₀−20% ζ (faint line).

The ratio of the maximum, stable feedback gain, γₘₐₓ, to the optimum feedback gain, γₒₚₜ, can be estimated by using the expression for these quantities which are

$${γ}_{max} \approx \frac{2 {ζ}_{a} {M}_{1} {ω}_{1}^{2}}{{ω}_{a}}$$

$${γ}_{opt} \approx \frac{2 M {ω}_{1}}{π}$$

where M is the mass of the panel, ωₗ its first natural frequency, M₁ the model mass at this frequency, assumed to be approximately M/JI, and ωₐ and ζₐ are the natural frequency and damping ratio of the actuator, so that

$$\frac{{γ}_{max}}{{γ}_{opt}} \approx {ζ}_{a} \frac{{ω}_{1}}{{ω}_{a}} .$$

This ratio is greater than unity in the simulations presented here when the actuator natural frequency is 10 Hz, as in FIG. 7, but less than unity when the actuator natural frequency is 20 Hz, as in FIG. 9.

It will be appreciated that the measure of force referred to above used to calculate the power absorbed, could be derived from signals other than the gain control signal, u. For example, a modified embodiment of the vibration control apparatus of FIG. 8 may include a force sensor to directly measure force, and the output of the sensor received and processed by the control arrangement.

A method and apparatus of automatically tuning the gain of a local velocity feedback controller has been discussed, based on the maximisation of the local absorbed power. Advantageously, it is shown that for broadband excitation the feedback gain that maximises the power absorbed by a local controller on a panel is almost the same as that which minimises the panel's overall kinetic energy.

In the case of an inertial actuator the applied force is inferred from the measured velocity, control signal and the modelled response and input impedance of the actuator. The estimated power absorbed by the inertial actuator is a good approximation to its true value even if there are significant differences between the true values of the actuator's natural frequency and damping ratio and the estimated values. This demonstrates that this approach to self-tuning is robust to the kind of changes in the response of the actuator that are likely to occur over time or with changing temperature. If the actuators are constructed to a reasonable tolerance, it may be possible to use a single model of their response in all manufactured feedback control units.

One aspect of self-tuning with the use of inertial actuators is the need to avoid feedback gains for which the system becomes unstable, since this will cause significant enhancement of the vibration and, potentially, damage. The optimal feedback gain can be kept well below the unstable limit provided the actuator resonance frequency is well below the first natural frequency of the panel and the actuator is well damped, although this is not always possible in practice. The maximum stable feedback gain also depends on the dynamics of the structure to which the controller is attached and on the number of local control units on the structure. It may thus be necessary in these cases to develop supplementary methods of assessing how close the feedback gain is to the unstable limit, so that this can be avoided. It will be appreciated that the control problem becomes significantly harder if the actuators are not well suited to feedback control on the structure being controlled.

What is claimed is:

1. Vibration control apparatus for controlling vibration of a structure, the apparatus comprising,
an inertial actuator,
a velocity sensor to measure the velocity of vibration of the structure, and
a controller to provide a gain control signal to the actuator,
wherein, the controller arranged to determine the gain control signal using at least a measure of velocity from the velocity sensor and a measure of force applied by the actuator to the structure, and wherein the controller arranged to use the measure of velocity and the measure of force applied to determine a measure of power absorbed by the actuator, and the controller further arranged to use the measure of power to determine the gain control signal.

2. Apparatus as claimed in claim 1, the controller arranged to calculate the measure of power absorbed by determining the product of the measure of velocity and the measure of force applied.

3. Apparatus as claimed in claim 1, the controller arranged to determine the measure of force applied using the gain control signal sent to the actuator.

4. Apparatus as claimed in any of claims 1 to 3 comprising a force sensor to measure the force applied by the actuator to provide to the controller a measure of the force applied.

5. Apparatus as claimed in claim 1 in which the velocity sensor comprises an accelerometer.

6. Apparatus as claimed in claim 1, the velocity sensor arranged to be attached to the structure and local to the inertial actuator.

7. Apparatus as claimed in claim 1 which comprises a compensator to reduce the apparent natural frequency of the actuator.

8. Apparatus as claimed in claim 7 in which the compensator comprises a null to compensate for the natural frequency of the actuator and a resonance of a frequency lower than the apparent natural frequency.

9. Apparatus as claimed in claim 1 in which the controller has been configured during an initial set-up procedure during which a measured on-line response of the velocity sensor to the control signal is used to suitably configure the controller.

10. Apparatus as claimed in claim 9 in which the controller has been configured during the initial set-up procedure using an actuator response and the response is deduced from the measured on-line response of the velocity sensor.

11. Apparatus as claimed in claim 7 in which the compensator has been configured during an initial set-up procedure using an actuator response deduced from on-line measurements of the response of the velocity sensor.

12. A controller for a vibration control apparatus, the controller comprising a processor, the processor arranged to receive an input indicative of a measure of velocity of vibration of a structure and an input indicative of a measure of force applied to the structure by an inertial actuator, and the processor arranged to provide a gain control signal for the inertial actuator using at least the measure of velocity and the measure of force applied, and wherein the controller arranged to use the measure of velocity and the measure of force applied to determine a measure of power absorbed by the actuator, and the controller further arranged to use the measure of power to determine the gain control signal.

13. A method of controlling vibration in a structure using an inertial actuator, the method comprising,
determining a measure of velocity of vibration of the structure,
determining a measure of force applied by the actuator,
using at least the measure of velocity and the measure of force to determine a gain control signal to the actuator, and using the measure of velocity and the measure of force applied to determine a measure of power absorbed by the actuator, and using the measure of power to determine the gain control signal.
